(19) United States
(12) Patent Application Publication
(10) Pub. No.: US 2026/0278457 A1
(43) Pub. Date: Sep. 17, 2026

(54) PREASSEMBLED WEAKLY SUPERVISED MACHINE LEARNING

(71) Applicant: NEC Laboratories Europe GmbH, Heidelberg (DE)

(72) Inventors: Gurkan SOLMAZ, Heidelberg (DE); Flavio CIRILLO, Heidelberg (DE)

(21) Appl. No.: 19/166,891

(22) PCT Filed: Aug. 16, 2023
(86) PCT No.: PCT/IB2023/058211

§ 371 Date: Sep. 19, 2025

Related U.S. Application Data
(60) Provisional application No. 63/503,746, filed on May 23, 2023.

(51) Int. Cl. G06N 20/00

(52) U.S. Cl. CPC G06N 20/00

(57) ABSTRACT

A computer-implemented method for generation of a machine learning model (e.g., a neural network) using weak supervision includes generating a labeling matrix of labeling function outputs by applying labeling functions to data features, and preassembling the labeling function outputs together with the data features for each data point to generate a training dataset. The machine learning model is trained using the training dataset. The method can be applied to a number of use cases including, but not limited to use cases in digital medicine and automated or personalized healthcare, AI-assisted drug development or vaccine development, material or composition development, smart factories, smart industry, smart districts, market segmentation, recommender systems, predictive maintenance and energy control, to optimize artificial intelligence (AI) and machine learning (ML) predictions or to support decision making.

### CROSS-REFERENCE TO PRIOR APPLICATION

This application is a U.S. National Phase application under 35 U.S.C. § 371 of International Application No. PCT/IB2023/058211, filed on Aug. 16, 2023, and claims benefit to U.S. Provisional Application Ser. No. 63/503,746 filed on May 23, 2023, the entire contents of which are hereby incorporated by reference herein. The International Application was published in English on Nov. 28, 2024 as WO 2024/241085 A1 under PCT Article 21(2).

### FIELD

The present invention relates to Artificial Intelligence (AI) and machine learning (ML), in particular, a method, system and computer-readable medium for preassembled weakly supervised machine learning.

### BACKGROUND

Existing frameworks for weakly supervised machine learning, such as the data programming framework Snorkel (see Ratner, Alexander, et al., “Snorkel: Rapid training data creation with weak supervision,” Proceedings of the Very Large Databases (VLDB) Endowment International Conference on VLDB, Vol. 11, No. 3, NIH Public Access (2017), which is hereby incorporated by reference herein) do not provide satisfactory accuracy in popularly used datasets, especially in the case of detection scenarios/application domains, such as in smart districts. Most frameworks consider improving the accuracy by using additional methods such as active learning or a small set of ground-truth data, called “gold labels” in combination with the base weak supervision pipeline (see Gonsior, Julius, et al., “WeaKAL: Combining active learning and weak supervision,” Discovery Science: 23rd International Conference, D S 2020, Thessaloniki, Greece, Oct. 19-21, 2020, Proceedings 23, Springer International Publishing (2020), which is hereby incorporated by reference herein).

### SUMMARY

In an embodiment, the present invention provides a computer-implemented method for generation of a machine learning model (e.g., a neural network) using weak supervision. The method includes generating a labeling matrix of labeling function outputs by applying labeling functions to data features, and preassembling the labeling function outputs together with the data features for each data point to generate a training dataset. The machine learning model is trained using the training dataset. The method can be applied to a number of use cases including, but not limited to use cases in digital medicine and automated or personalized healthcare, AI-assisted drug development or vaccine development, material or composition development, smart factories, smart industry, smart districts, market segmentation, recommender systems, predictive maintenance and energy control, to optimize artificial intelligence (AI) and machine learning (ML) predictions or to support decision making.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically illustrates a weak supervision machine learning pipeline;

FIG. 2 schematically illustrates a weak supervision machine learning pipeline with preassembly according to an embodiment of the present invention;

FIG. 3 schematically illustrates a weak supervision machine learning pipeline with preassembly of relevant information from labeling functions in the training dataset according to an embodiment of the present invention;

FIG. 4 schematically illustrates preassembling phases for the data features and rule (labeling function) outputs according to an embodiment of the present invention;

FIG. 5 schematically illustrates a prediction of new/unseen data points using the trained end classifier model according to an embodiment of the present invention;

FIG. 6 schematically illustrates a preassembled weak supervision model according to an embodiment of the present invention;

FIG. 7 schematically illustrates a weak supervision machine learning pipeline with preassembly of additional features according to an embodiment of the present invention;

FIG. 8 schematically illustrates a method of adding content of labeling functions as input features by encoding the relevant labeling function content, in addition to the preassembling model, according to an embodiment of the present invention;

FIG. 9 schematically illustrates a method of adding content of labeling functions as input features by encoding the relevant labeling function content, in addition to the preassembling model, according to an embodiment of the present invention, with an indefinite number of labeling functions, labeling function encodings, labeling function encoding packets and data points;

FIG. 10 schematically illustrates a method of online learning with a new/unseen data point according to an embodiment of the present invention;

FIG. 11 schematically illustrates application of the method and system according to an embodiment of the present invention for predictive maintenance;

FIG. 12 schematically illustrates application of the method and system according to an embodiment of the present invention for market segmentation;

FIG. 13 schematically illustrates application of the method and system according to an embodiment of the present invention for an energy scheduler in a smart district;

FIG. 14 schematically illustrates application of the method and system according to an embodiment of the present invention for an energy controller for a smart building with a digital twin;

FIG. 15 graphically illustrates experimental performance results; and

FIG. 16 schematically illustrates a weak supervision model according to an embodiment of the present invention.

### DETAILED DESCRIPTION

Embodiments of the present invention provide a method and system for preassembled end-to-end weakly-supervised machine learning. In particular, the method considers a set of rules (heuristic functions or labeling functions, which terms may be used interchangeably) and raw data for training, validation and testing. The method is based on “preassembling” all the relevant information (e.g., information about data features, labeling function outputs and labeling function content) and usage of a classification model, both of which are specialized on the preassembled data. The framework can be applied to smart districts (e.g., smart cities, buildings, etc.) for more effective situation awareness.

According to a first aspect, the present disclosure provides the present invention provides a computer-implemented method for generation of a machine learning model using weak supervision. The method includes generating a labeling matrix of labeling function outputs by applying labeling functions to data features, and preassembling the labeling function outputs together with the data features for each data point to generate a training dataset. The machine learning model is trained using the training dataset.

According to a second aspect, the present disclosure provides the method according to the first aspect, further comprising generating one or more predictions based on the labeling function outputs and including the one or more predictions in the training dataset, wherein the labeling function outputs together with the data features for each data point are used as input for training the machine learning model, and wherein the one or more predictions are used as output for training the machine learning model.

According to a third aspect, the present disclosure provides the method according to the first or second aspect, wherein the machine learning model is trained to optimize a loss based on the training dataset, which provides the labeling function outputs together with the data features for each data point as input for the training and the one or more predictions based on the labeling function outputs as output for the training.

According to a fourth aspect, the present disclosure provides the method according to any of the first to third aspects, wherein a loss function is used for training the machine learning model as follows:

$$Loss ( θ ) = \frac{1}{\vert D \vert * m} {\sum }_{i = 1}^{\vert D \vert} {\sum }_{j = 1}^{m} Error ( {y}_{predicted}^{i} \vert {f}_{1}^{i} , {f}_{2}^{i} , … {f}_{n}^{i} , {LF}_{1}^{i} , {LF}_{2}^{i} , … {LF}_{m}^{i} ; {LF}_{j}^{i} )$$

where:

$${LF}_{j}^{i}$$

represents a prediction value of the j^{th} labeling function's prediction value over a respective data point indexed with i,
D represents the data points including the data points that are abstained by one or more of the labeling functions,
m represents a total number of the labeling functions,

$${f}_{1}^{i} , {f}_{2}^{i} , … {f}_{n}^{i}$$

represent the data features for each data point in the training dataset as input features,

$${LF}_{1}^{i} , {LF}_{2}^{i} , … , {LF}_{m}^{i}$$

represent the labeling function outputs in the training dataset as additional input features, and

$${y}_{predicted}^{i}$$

is a prediction or the machine learning model based on the input features.

According to a fifth aspect, the present disclosure provides the method according to any of the first to fourth aspects, further comprising: encoding content of the labeling functions as values to generate labeling function encodings, wherein the content includes input/output parameters, internal text, logic and/or architecture of the labeling functions; and preassembling the labeling function encodings in the training dataset.

According to a sixth aspect, the present disclosure provides the method according to any of the first to fifth aspects, wherein the labeling function encodings are preassembled in the training dataset as labeling function encoding packets for each data point including a set of the labeling function encodings for each labeling function.

According to a seventh aspect, the present disclosure provides the method according to any of the first to sixth aspects, wherein a loss function is used for training the machine learning model as follows:

$$Loss ( θ ) = \frac{1}{\vert D \vert * m} {\sum }_{i = 1}^{\vert D \vert} {\sum }_{j = 1}^{m} Error ( {y}_{predicted}^{i} \vert {f}_{1}^{i} , {f}_{2}^{i} , … {f}_{n}^{i} , {LF}_{1}^{i} , {LF}_{2}^{i} , … {LF}_{m}^{i} , {LFEP}_{1}^{i} , {LFEP}_{2}^{i} , … {LFEP}_{t}^{i} ; {LF}_{j}^{i} )$$

where:

$${LF}_{j}^{i}$$

represents a prediction value of the j^{th} labeling function's prediction value over a respective data point indexed with i,
D represents the data points including the data points that are abstained by one or more of the labeling functions,
m represents a total number of the labeling functions,

$${f}_{1}^{i} , {f}_{2}^{i} , … {f}_{n}^{i}$$

represent the data features for each data point in the training dataset as input features,

$${LF}_{1}^{i} , {LF}_{2}^{i} , … {LF}_{m}^{i}$$

represent the labeling function outputs in the training dataset as additional input features,

$${LFEP}_{1}^{i} , {LFEP}_{2}^{i} , … {LFEP}_{t}^{i}$$

represents t number of the labeling function encoding packets in the training dataset as further input features, and

$${y}_{predicted}^{i}$$

is a prediction of the machine learning model based on the input features.

According to an eighth aspect, the present disclosure provides the method according to any of the first to seventh aspects, further comprising shuffling and batching the training dataset prior to using the training dataset to train the machine learning model.

According to a ninth aspect, the present disclosure provides the method according to any of the first to eighth aspects, further comprising fine-tuning the machine learning model using at least one new and unseen data point for which the machine learning model makes a prediction, wherein the labeling functions are applied to the at least one new and unseen data point and are preassembled with the at least one new and unseen data point to generate a further training dataset used to further train the machine learning model in an iterative manner.

According to a tenth aspect, the present disclosure provides the method according to any of the first to ninth aspects, wherein the data features include values from sensors and data sources in a smart industry system and the labeling functions include heuristics on system fault based on experience, and wherein the machine learning model is trained for predictive maintenance of components of the smart industry system and is implemented in a maintenance scheduling tool.

According to an eleventh aspect, the present disclosure provides the method according to any of the first to tenth aspects, wherein the data features include customer data and/or data from a digital twin simulation and the labeling functions include marketing rules, and wherein the machine learning model is trained for market segmentation and is implemented in a store recommendation tool.

According to a twelfth aspect, the present disclosure provides the method according to any of the first to eleventh aspects, wherein the data features include data collected from a smart district including values from sensors indicating energy usage in the smart district and the labeling functions include rules on energy usage in the smart district, and wherein the machine learning model is trained for energy predictions for the smart district and is implemented in a scheduler tool configured to control energy usage in the smart district based on predictions of the machine learning model.

According to a thirteenth aspect, the present disclosure provides the method according to any of the first to third aspects, wherein the data features include values from sensors and data sources in a smart building and/or data from a digital twin simulation of the smart building and the labeling functions include heuristics on actions of the digital twin simulation, and wherein the machine learning model is trained for predicting digital twin actions and is implemented in an energy controller of the smart building.

According to a fourteenth aspect, the present disclosure provides a computer system comprising one or more hardware processors which, alone or in combination, are configured to provide for execution of a method for generation of a machine learning model using weak supervision according to any of the first to thirteenth aspects.

According to a fifteenth aspect, the present disclosure provides a tangible, non-transitory computer-readable medium having instructions thereon, which, upon being executed by one or more processors provide for execution of a method for generation of a machine learning model using weak supervision according to any of the first to thirteenth aspects.

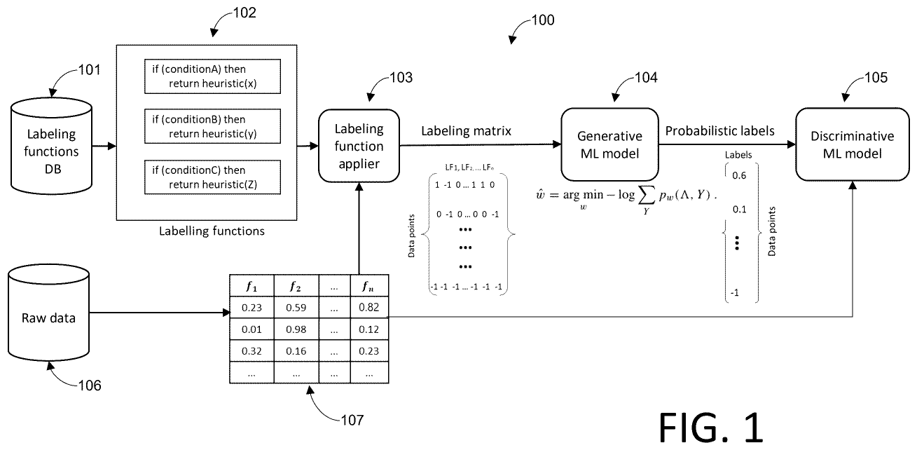

FIG. 1 illustrates an existing weakly supervised machine learning pipeline 100 as a data programming framework. In the existing weakly supervised machine learning pipeline 100, a labeling function applier 103 applies labeling functions 102 from a labeling functions database 101 to raw data features (input features) 107 from a database of raw data 106 to generate a labeling matrix that is used as input to a generative ML model 104. The generative ML model 104 is trained to output probabilistic labels for the data points that are then used as input to a discriminative ML model 105.

The raw data (input features) 107 comprise a plurality of data points (shown in rows in FIG. 1) and each of the data points from the database of raw data 106 can comprise a plurality of data features f₁, f₂ . . . fₙ. For example, a data point could represent a sensor reading or multiple sensor readings at a given time, or can represent different persons, structures (e.g., chemical structures), patients, entities, etc. having various features (e.g., temperature, CO₂ levels, etc. in the case of a smart building or sex, age, medications, etc. in the case of patients). Not shown in FIG. 1 is that a domain expert could manually apply labels to the data features before applying them to the discriminative ML model 105. In contrast, the application of labeling functions 102 is an automatic rules-based labeling performed by the labeling function applier 103 applying the labeling functions 102 present in the labeling functions database 101 to raw data (input features) 107 (e.g., applying a threshold to values of the data points). Typically, each of the labeling functions 102 can only label part of the data, and therefore may abstain (no prediction, represented by −1) if it cannot label a data point. The labeling matrix shows the label applied to each of the data points by each of the labeling functions 102 LF₁, LF₂ . . . . LFₙ, and is the only input to the generative ML model 104. The generative ML model 104 outputs a single label for each data point, for example the most common or probabilistic (e.g., max likelihood). A-1 represents no prediction. These labels are then fed to the discriminative ML model 105, which can be a number of different ML models.

Disadvantages include that the generative model uses only the labeling matrix and the discriminative ML model 104 uses a dataset that has filtered out data points corresponding to undecided labels. Further limitations include coarse information, lack of generalization, dataset features being used late in the pipeline and a good cumulative LF coverage is necessary. Further, with not enough labeling functions the model might not converge, and the labeling functions are not always easy to implement. Also, the current data programming approach does not check the LFs' labels for predictions, and does not train using new/unseen data. Due to the limited information, the discriminative ML model 105 performs blind generalization.

There are various reasons why existing weakly supervised machine learning systems do not provide satisfactory predictions, which may depend on the scenario, however in most situations they are due to inaccuracy of the weak supervision sources (which are also referred to interchangeably as rules or labeling function), an unsatisfactory number of existing data points, low quality of the generative model, lack of convergence or generalization of the end discriminative model and/or insufficient coverage of the labeling functions (how many data points are labeled by how many labeling functions).

A study, which focused on “end-to-end” training of the weak supervision, proposed the existing two models (generative and discriminative) may be replaced with an end-to-end model (see Rühling Cachay, Salva, et al., “End-to-end weak supervision,” Advances in Neural Information Processing Systems 34:1845-1857 (2021), which is hereby incorporated by reference herein). However, the end-to-end model proposed by the study has multiple machine learning models, which means that the accuracy relies on the performance of all models successfully trained and having good discriminative abilities. Similarly, Sam, Dylan, et al., “Losses over Labels: Weakly Supervised Learning via Direct Loss Construction,” arXiv preprint arXiv: 2212.06921 (2022), which is hereby incorporated by reference herein, describe the problem of using labels for losses instead as an alternative with one unified model, whereas there is still a weighting mechanism that needs to be taken into account before the end model, and also propose comparing the input parameters with the data features to take the dependencies between them for weighting.

On the other hand, automated machine learning (AutoML) frameworks have been popularly used and adapted to applications such as object detection in autonomous driving (see He, Xin, et al., “AutoML: A survey of the state-of-the-art,” Knowledge-Based Systems 212:106622 (2021); and Huang, Yu, et al., “Survey of state-of-art autonomous driving technologies with deep learning,” 2020 IEEE 20th international conference on software quality, reliability and security companion (QRS-C), IEEE, (2020), each of which is hereby incorporated by reference herein). Although these models provide sufficient accuracy in many scenarios, they mostly rely on the existence of ground-truth data sets (or labeled/annotated data) and training in a fully-supervised manner. In similar domains, such as computer vision, the weakly-supervised learning is adapted by custom models as opposed to having a common framework based on a working approach. For instance, the resolution of the data that is used can be lower (e.g., annotating a subset of frames in a video instead of all frames in the video) and still be beneficial for training. However, although in lower granularity, these models still rely on ground-truth. The existence of ground-truth, either for custom weak supervision or for active learning, may not be applicable to certain scenarios. These methods, however, can complement the weak supervision pipeline when applicable (e.g., when a small set of ground-truth is available).

Embodiments of the present invention provide solutions for overcoming the weak supervision problem by tackling the technical challenges of learning from existing information (raw data) and weak supervision (labeling functions). Embodiments of the present invention may replace the existing systems for core weak supervision, and/or used to complement and enhance the computational functionality of the existing systems (e.g., with active learning or small ground-truth) to generate more accurate and reliable outcomes.

With regard to the weak supervision problem of existing technology, current weak supervision approaches rely on having a certain amount of weakly labeled data points in order to succeed on training the machine learning model. However, that is often not the case in practice and most of the raw data points that do not have a weak label or that have conflicting labels are dismissed. Current approaches need specific knowledge and effort for creating, implementing, and training a “generative process”, which refers to any applied statistics, machine learning, or heuristics before the end classification model (discriminative model) as part of the generative process.

Embodiments of the present invention define a new framework for weak supervision. The framework addresses the weak supervision problem as an optimization problem and the solution of the optimization problem results in the classification. Moreover, embodiments of the present invention provide a unique solution to the weak supervision problem through a new preprocessing module, which is preprogrammed hardware and referred to herein as a “preassembling module”. The preassembling module is included in the weakly-supervised machine learning pipeline. Moreover, embodiments of the present invention provide to use machine learning models tailored for the package/dataset created by the preassembling module, which is referred to herein as “preassembled data”. These models can be fully-supervised machine learning models or other applicable models.

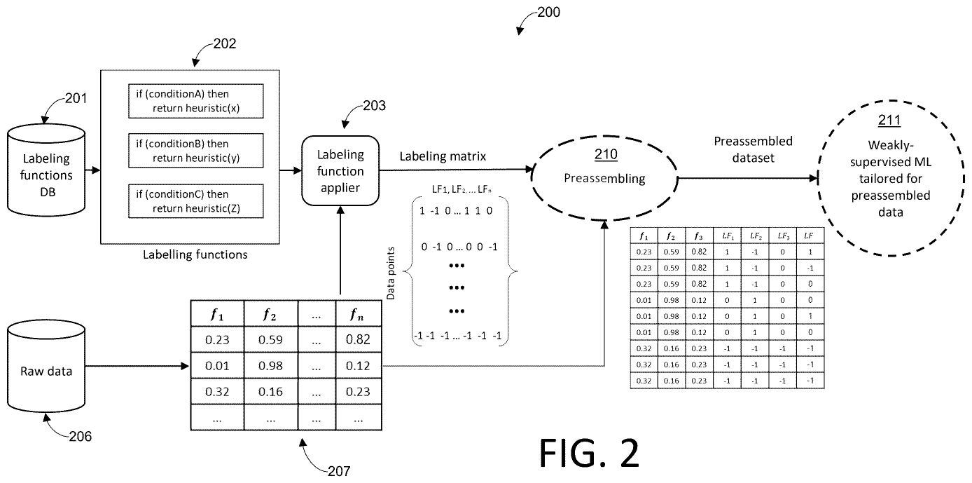

FIG. 2 schematically illustrates a weakly supervised machine learning pipeline 200 according to an embodiment of the present invention. In the weakly supervised machine learning pipeline 200, a labeling function applier 203 applies labeling functions 202 from a labeling functions database 201 to data features 207, for example raw data features (input features), from a database of raw data 106 to generate a labeling matrix that is used as input to a preassembling module 210 according to an embodiment of the present invention. The preassembling module 210 outputs a preassembled dataset that can be used as input to a module for weakly-supervised ML tailored for preassembled data 211 according to an embodiment of the present invention.

Relative to existing systems, embodiments of the present invention provide the following components which enable to enhance the accuracy, reliability and usability for different applications: 1) the preassembling module 210; and 2) the module for weakly-supervised ML tailored for preassembled data 211, which also enables to solve different problems compared to existing systems. Moreover, as a result of the model, the raw data does not need to be fed to the end model, but to the preassembling module 210. The preassembling may contain a step where the content of the labeling functions (LFs) are learned or directly utilized as features for machine learning. The content includes the input/output parameters as well as internal text, logic or architecture.

In addition, embodiments of the present invention provide for online learning for the new/unseen data points that can be used for prediction, following the same preassembling method. Embodiments of the present application, including the new system framework or improvements to existing systems built based on the defined framework with the preassembling module, have a number of practical applications, thereby enabling further improvements in a number of technical fields, such as smart districts, predictive maintenance, energy control, etc. through the improved accuracy and reliability of the predictions.

The preassembling module 210 is responsible for bringing all relevant information together and creating a new package/dataset as the preassembled data. The relevant information includes the following: raw data features (input features) 207, labels that are outputs of the labeling functions 202 as additional input features, and labels that are outputs of the labeling functions 202 as output features. The newly created (preassembled) data should be in a format that is consumable by machine learning models, for example in a matrix, strings, or tabular format.

The raw data features 207 and the labels that are outputs of the labeling functions 202 as additional input features contain all relevant information for any given data point, meaning what raw data features the data point has and what each of the labeling functions predicted for the given data point. For instance, a labeling function can predict 1 (positive), 0 (negative), or −1 (abstain) for a binary classification. The −1 (abstain) means that the labeling function abstains from classifying the given data point. For multinomial data or numerical/continuous data (e.g., regression) there can be more output possibilities.

The input of the preassembling module 210 is the outputs of labeling function applier 203, as a labeling matrix, as well as the raw data features 207. The output of the preassembling module 210, which can include a model for the preassembling, is all the relevant information packed and ready to be consumed by a machine learning model.

Exemplary embodiments of the present invention provide a concrete way of implementing the preassembling, whereas different implementations can be applied for the same or similar components within the scope of embodiments of the present invention.

Advantageously, the preassembling module 210 can be implemented without any machine learning or statistical techniques, as the preassembling is designed to gather information all in one package.

The module for weakly-supervised ML tailored for preassembled data 211 comprises a model that makes the optimization for training and prediction of the outputs, given the input of the preassembled data. The preassembled data consists of the raw data features (input features) 207 and the labeling function outputs as additional input features, as well as the labeling function outputs as the output features. The “weakly-supervised ML” model is a supervised ML model that produces its output feature by processing the weak supervision sources (weak labels coming as output of the labeling functions). The weakly-supervised model is part of the system architecture to provide the functionality to train and predict the weak labels given all relevant information: For a given data point, what data features exist and what are the labeling functions' predictions. The optimization is based on the outputs that are given as the labeling functions' outputs. The optimization reduces the loss for predicting those outputs given all relevant data and by learning from the data patterns.

Unlike in FIG. 1, in which the data provided to the ML models only includes labeling function outputs, the present invention provides to improve machine learning by providing more data for the weakly-supervised ML tailored for preassembled data 211, including the raw data features 207, the labeling function outputs of each labeling function LF₁, LF₂ . . . . LFₙ and a prediction of the label for each data point LF, for example by repeating the data point in the table so that all labeling function outputs are included in the column LF. Advantageously, the weakly-supervised ML tailored for preassembled data 211 is adapted to consume data in this format. The provision of all such data for the weakly-supervised ML tailored for preassembled data 211 enables to avoid assumptions and bias to the data before the ML model. Further, in contrast to existing technology, in which −1 (abstain) labels are not used in training, it has been found according to embodiments of the present invention that using all available data for the weakly-supervised ML tailored for preassembled data 211, including abstains, improves the learning and further helps to avoid assumptions and bias by allowing each labeling function output to be left to ML.

The labels are shown herein as binary values (1, 0, −1, where −1 means abstain) for ease of explanation. However, it will be appreciated by those of ordinary skill in the art that the labels can be other values, such as probabilistic values between 0 and 1, according to embodiments of the present invention.

In a method according to an embodiment of the present invention for generating a machine learning model with preassembling, the following steps are performed:
Step 1. Create a database with (raw or preprocessed) data features.
Step 2. Create a database with labeling functions (rules).
Step 3. Create a labeling matrix: Apply the labeling functions on the data points with the data features.
Step 4. Preassembling module: For each data point, merge or bring together the raw data features and labeling function outputs as input features.
Step 5. Preassembling module: For each data point, create one or multiple predictions based on the labeling functions' predictions on the data points. In the case of multiple predictions, duplicate the rows with input features and set the output feature based on the predictions.
Step 6. Weakly-supervised machine learning tailored for preassembled data module: Create a (multinomial) machine learning model that optimizes the loss based on the input features given in Step 4 and output features given in Step 5. Thus, the model learns to predict similar to the output features, given the input features.
Step 7. Weakly-supervised machine learning tailored for preassembled data module: For any new/unseen data point, predict the label using the trained model in Step 6. In case of abstain prediction (e.g., −1), choose the label with the second highest probability (e.g., choose 1 or 0 based on their probabilities).

Among the improvements to computer functionality, such as improved accuracy and reliability of computations and machine learning outputs, embodiments of the present invention do not require any machine learning, heuristics or statistics before training an end classification model, thereby reducing the need for computational time and resources prior to training. Instead, embodiments of the present invention “preassemble” all available data in a format that is digestible by any relevant machine learning model. The solution can be applied to binary classification or multinomial classification tasks (e.g., labeling functions with multinomial predictions).

Thus, an advantage of the preassembling is enabling to avoid any effort on applying statistics, machine learning or heuristics before the end model, and purely relying on machine learning (as the end model). In contrast, to apply a generative process, one would need to determine a statistical model and configure the parameters, or implement different techniques. Thus, this effort is transferred to the end model (machine learning). Further, embodiments of the present invention enable to avoid the need for creating/training a generative model or any heuristics before the end model. Moreover, embodiments of the present invention enable to avoid filtering out any data point, including data points that are abstained by labeling functions (where labeling functions do not make any prediction).

Further, in contrast to existing approaches, embodiments of the present invention advantageously do not apply any bias before bringing the data to the end model. Instead, all available data (data features, labeling function outputs or labeling function encodings) is collected and simply aggregated to the end model. Embodiments of the present invention also advantageously provide this data aggregation in a format that is directly usable by a classification model by the preassembling. The preassembling can be implemented in different ways, but advantageously does not include any bias such as in heuristic approaches or parameter setting. This avoiding of any bias while still presenting all relevant information to the end model provides the advantage of avoiding losing any relevant information before the end model (and/or avoiding error or abstraction before the end model), thus it also enables high accuracy end predictions. An end machine learning model can thereby be provided that performs very well and does not get penalized by a previous generative process which does not perform very well.

In the following, the implication of the proposed solution according to embodiments of the present invention on the loss function is demonstrated with regard to an exemplary embodiment.

The existing loss function (Loss) of the data programming pipeline of FIG. 1, or Snorkel, is defined as follows:

$$Loss ( θ ) = \frac{1}{\vert S \vert} {\sum }_{i = 1}^{\vert S \vert} Error ( {y}_{predicted}^{i} \vert {f}_{1}^{i} , {f}_{2}^{i} , … {f}_{n}^{i} ; {y}_{probabilistic}^{i} )$$

where, f₁, f₂, . . . fₙ represent the input features (data features), i represents the index of a data point that is used for training 0 represents the parameters of the end machine learning model (discriminative model) for the classification and, S represents the “subset of all data points which are labeled” (not abstained) by the generative process and,

$${y}_{predicted}^{i}$$

represents thje output value predicted by the discriminative (end) model and

$${y}_{probabilistic}^{i}$$

represents the output value given by the generative process (generative model) as output for the given data point i. n represents the number of input features (data features on a raw or preprocessed data). Given these values, different error metrics can be implemented in the error function and the Loss can be represented as the average loss over all data points that are used in the training, where |S| represents the number of data points that are labeled by the generative process and used in the training. This embodiment gives a simple example to introduce the main optimization problem, whereas variations of the loss and error functions can be implemented.

The newly proposed loss function (Loss) is defined based on the proposed positioning of the data programming problem with the preassembling of all relevant data. This starts with the scenario where the labeling function outputs are included. The newly proposed loss function can be defined as follows:

$$Loss ( θ ) = \frac{1}{\vert D \vert * m} {\sum }_{i = 1}^{\vert D \vert} {\sum }_{j = 1}^{m} Error ( {y}_{predicted}^{i} \vert {f}_{1}^{i} , {f}_{2}^{i} , … {f}_{n}^{i} , {LF}_{1}^{i} , {LF}_{2}^{i} , … {LF}_{m}^{i} ; {LF}_{j}^{i} )$$

where

$${LF}_{j}^{i}$$

represents the j^{th} labeling function's prediction value over the data point indexed with i. D represents “all” data points including the data points that are abstained by any or all labeling functions. m represents the number of all labeling functions. The prediction of the end model

$$( {y}_{predicted}^{i} )$$

is based on the given input features

$${f}_{1}^{i} , {f}_{2}^{i} , … {f}_{n}^{i} , L {F}_{1}^{i} , L {F}_{2}^{i} , … {LF}_{m}^{i} ;$$

such that the labeling functions' outputs are also given. The

$${y}_{p r obabilistic}^{i}$$

that normally represents the data given by any generative process (any process before the discriminative model, including any weighting or probabilistic or deterministic labeling) is replaced by the labeling functions predictions

$${LF}_{j}^{i} .$$

As the aggregation includes all labeling functions' outputs one by one, the mean value should also include the number of labeling functions m. Thus, both the input features and the output features are different in the newly proposed loss function.

A feature of the newly proposed loss function is its design to be inclusive as much as possible, both for the input features (including all labeling functions' outputs) as well as the output features (including outputs of all labeling functions over all data points). For example, the output features can include each labeling function output for each data point (repeating the data points in the table for each labeling function output). Thus, the preassembling repeats the data points based on the number of labeling functions used. The loss and error functions can be defined and implemented in different ways using any existing technique.

Another feature of the newly proposed loss function is its design to not to include any bias in the presented inputs or output features. In contrast, in existing loss functions, every existing model implements in one way or another certain bias, such as using different weights for different labeling functions, using different weights for different data points (such as in Sam, Dylan, et al.), estimating prediction values or reducing to only a prediction for one data point. In the newly proposed loss function, on the other hand, there is no bias or weighting mechanism necessary such that the input features from the data and the outputs of the labeling functions are represented without any weights or previous selection by any generative process (any process that is before training the predictive machine learning model). Thus, the machine learning model according to embodiments of the present invention, for its training, is presented with all available inputs and outputs without any previous assumptions or predictions before the training.

Further, the newly proposed loss function can be extended by inclusion of new possible inputs to further improve the inclusivity of the input features for the end machine learning model. These new inputs comprise anything that can be learned about the labeling functions, including the input/output parameters of labeling functions, content of labeling functions, or any information that can be gathered from information sources about the labeling functions. These features are also referred to herein as “labeling function encoding packets”. Various existing techniques (e.g., parsing information from the text) can be used to encode the information about labeling functions. These encodings are included in the loss function. Thus, a newly proposed extended loss function can defined as follows:

$$Loss ( θ ) = \frac{1}{\vert D \vert * m} {\sum }_{i = 1}^{\vert D \vert} {\sum }_{j = 1}^{m} Error ( {y}_{predicted}^{i} \vert {f}_{1}^{i} , {f}_{2}^{i} , … {f}_{n}^{i} , {LF}_{1}^{i} , {LF}_{2}^{i} , … {LF}_{m}^{i} , LFE {P}_{1}^{i} , {LFEP}_{2}^{i} , … {LFEP}_{t}^{i} ; {LF}_{j}^{i} )$$

where

$${LFEP}_{1}^{i}$$

represents “labeling function encoding packets” that encapsulate the labeling function encodings (LFEs). The number of labeling function encoding packets (LFEPs) are given as t, while this number depends on the implementation of the encodings. The extended loss function extends the inclusivity in the input features for the training with including any relevant labeling function-related information as input features given to the machine learning model (end/discriminative model).

In certain embodiments, the loss functions can be applied for binary classification, multinomial classification or any other relevant machine learning problem (e.g., a prediction problem for an applied domain) for calculating loss during the training of the end model.

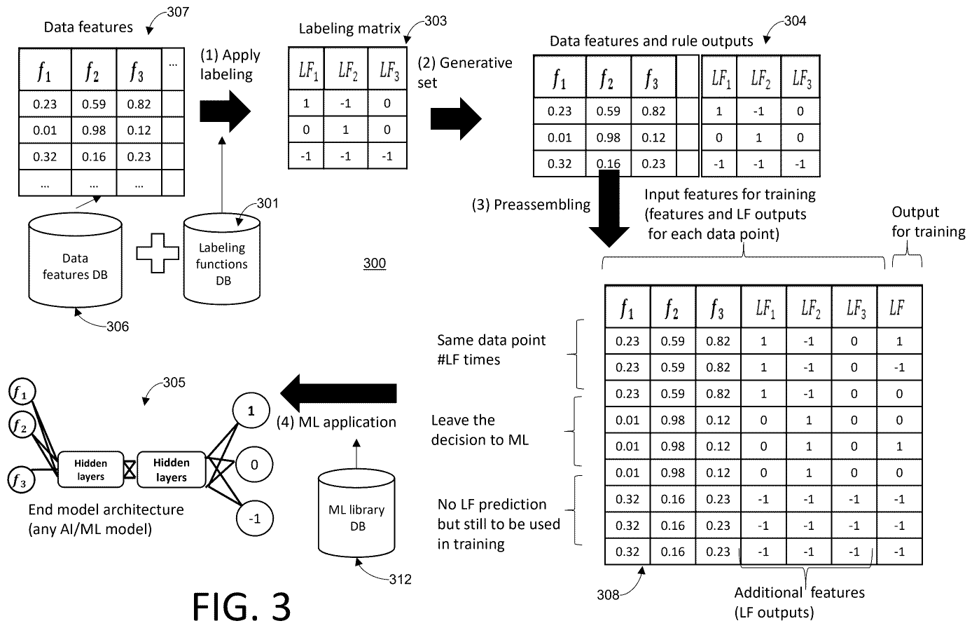

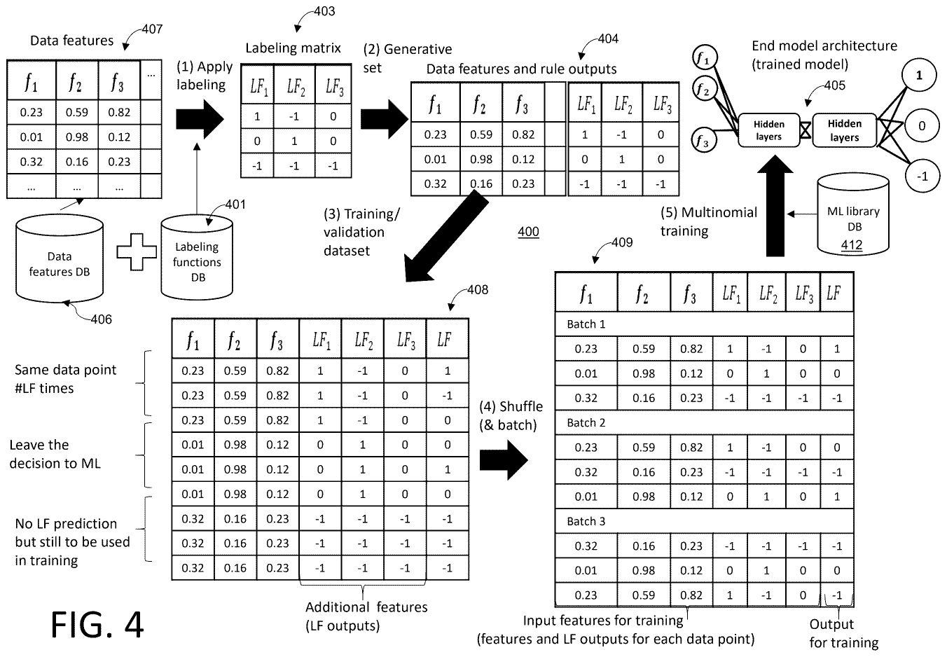

In the following, with reference to FIGS. 3 and 4, exemplary implementations of technical embodiments of two preassembling modules 300 and 400 are described. These embodiments of the preassembling modules 300 and 400 implement a method of preassembling as illustrated in FIGS. 3 and 4, respectively, through the steps given in parenthesis. In these embodiments, there are three data points, three features, and three labeling functions (LFs) that are considered for simplification, whereas in other implementations there can be any number of data points, features, labeling functions or data points. The steps of the methods are as follows:
Step (1) Apply labeling: The data features 307 or 407 are taken from a data features database (DB) 306 or 406 and the labeling functions are taken from a labeling functions DB 301 or 401. The labeling functions are applied to the data features 307 or 407, thereby creating a labeling matrix 303 or 403.
Step (2) Generative set: A “generative” set 304 or 404 is created, by attaching the labeling matrix 303 or 403 to the data features 307 or 407.
Step (3) Preassembling or generating training/validation dataset 308 or 408: Each data point is duplicated according to the number of LFs. If there are three LFs, they are duplicated twice, thus three data points are generated from each data point. For each such data point, the output of a specific labeling function is added (right-most column on the table).
Step (4) Shuffle (and batch) (FIG. 4 only): In some embodiments, the data can be shuffled and batches 409 are created to make it easier for the machine learning training optimization. This is a statistical method and can be randomly applied.
Step (5) Multinomial training (FIG. 4, see also step (4) ML application of FIG. 3): A multinomial end model 305 or 405 is trained using the input and output features of step (4) (or, for FIG. 3, the output features of step (3)) and an ML library DB 312 or 412, for example, containing existing models, which can be further trained.

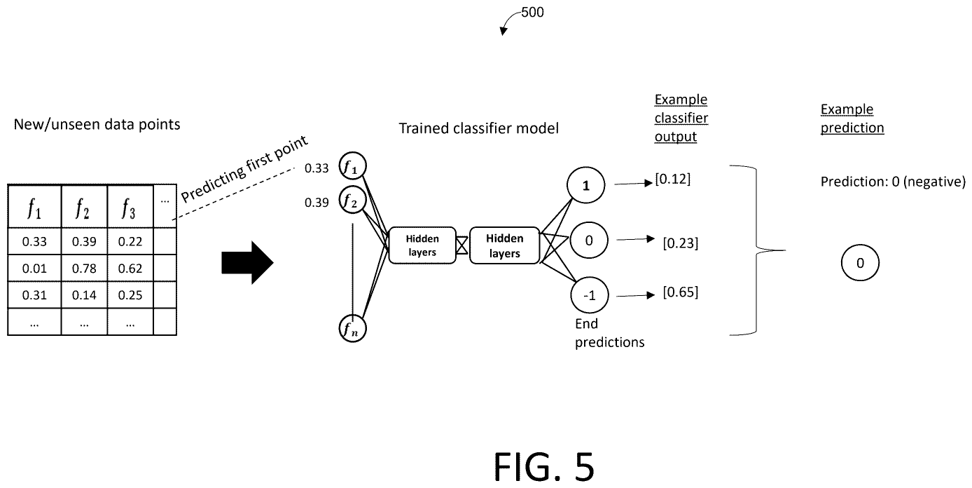

The trained multinomial model of the end model architecture 305 or 405 can make predictions such as 1, 0 or −1. Based on the application, given a new/unseen data point, this trained model is used to predict either the one with highest probability or highest among the non-abstain classes (0 or 1). The prediction procedure 500 for the new/unseen data point in an exemplary embodiment is illustrated in FIG. 5. In this example, the non-abstain class with highest probabilistic output (0.23) is considered as the predicted value (0-negative).

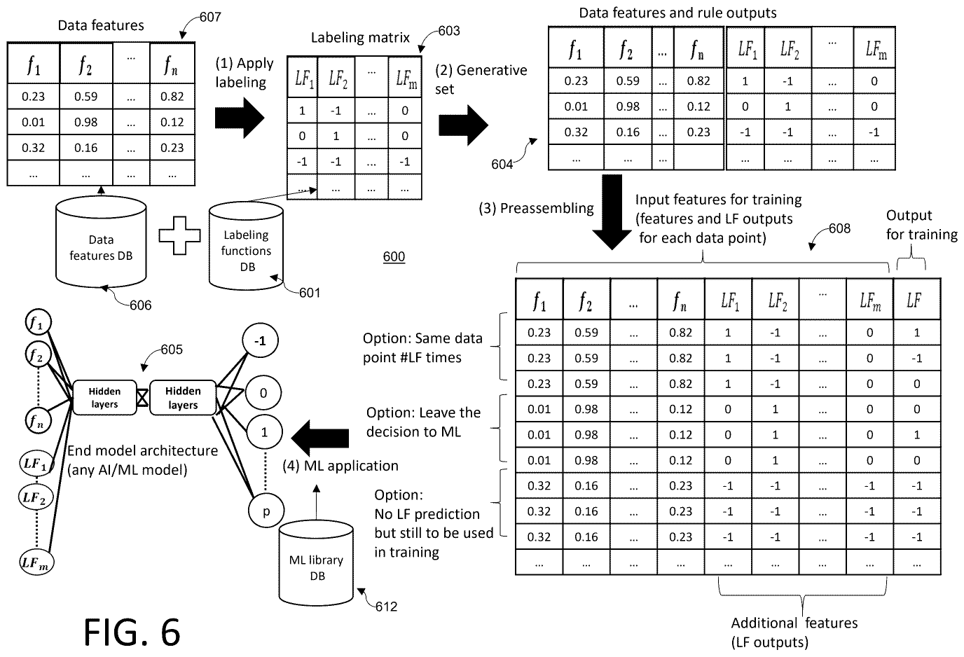

FIG. 6 illustrates another implementation of a technical embodiment of the preprocessing module 600 that applies the method with any number of data points, data features and LFs (e.g., a generalization of the embodiments of FIG. 3 or FIG. 4 with d data points, n data features and m LFs). The classification can be easily generalized to more than two (p) classes using existing techniques. This model can be applied to binary classification (0 or 1) or multinomial classification scenarios (e.g., p classes). The steps of the method are as follows:
Step (1) Apply labeling: The data features 607 are taken from a data features DB 606 and the labeling functions are taken from a labeling functions DB 601. The labeling functions are applied to the data features 607, thereby creating a labeling matrix 603.
Step (2) Generative set: A “generative” set 604 is created, by attaching the labeling matrix 603 to the data features 607.
Step (3) Preassembling or generating training/validation dataset 608: Each data point is duplicated according to the number of LFs. For each such data point, the output of a specific labeling function is added (right-most column on the table).
Step (4) ML application: A multinomial end model 605 is trained using the input and output features of step (3) and an ML library DB 612.

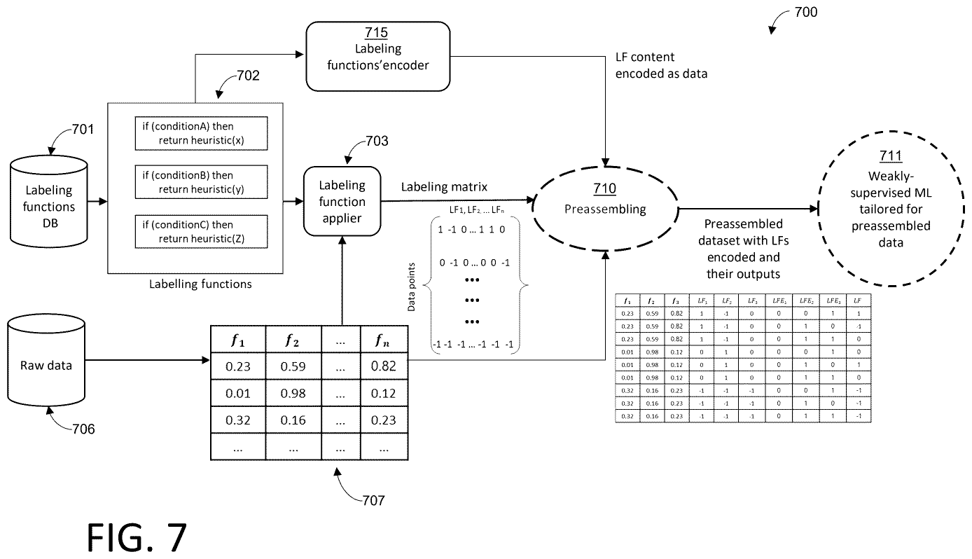

In the following, an exemplary implementation of a technical embodiment for learning from the labeling function content is described. This embodiment extends the preassembling by adding new features which describe the labeling function content as illustrated in FIG. 7. In particular, FIG. 7 shows a weakly supervised machine learning pipeline 700 according to an embodiment of the present invention having preassembling with additional features, wherein labeling functions-relevant information are encoded by a labeling functions' encoder 715 (see top of FIG. 7) and preassembled by a preassembling module 710 along with the labeling matrix (see middle of FIG. 7) and data features 707 (see bottom of FIG. 7). As before, the data features 707 are taken from a database of raw data 706, and the labeling functions 702 from a labeling functions DB are applied to the data features 707 by a labeling function applier 703 to generate the labeling matrix. The new features can be learned by the labeling functions' encoder 715 by any existing technique or advanced models such as pretrained language models, compilers and so on. The learning will be added to the preassembled dataset, such that, not only the outputs of labeling functions, but also the contents of the labeling functions will be used for training dataset in the end (for any ML/AI model).

This embodiment advantageously provides even more of the available data for the weakly-supervised ML for preassembled data. The labeling function encodings LFE₁, LFE₂, LFE₃ are shown as binary values in FIG. 7 for ease of explanation, but could also be a value or string of values depending on the encoder model used.

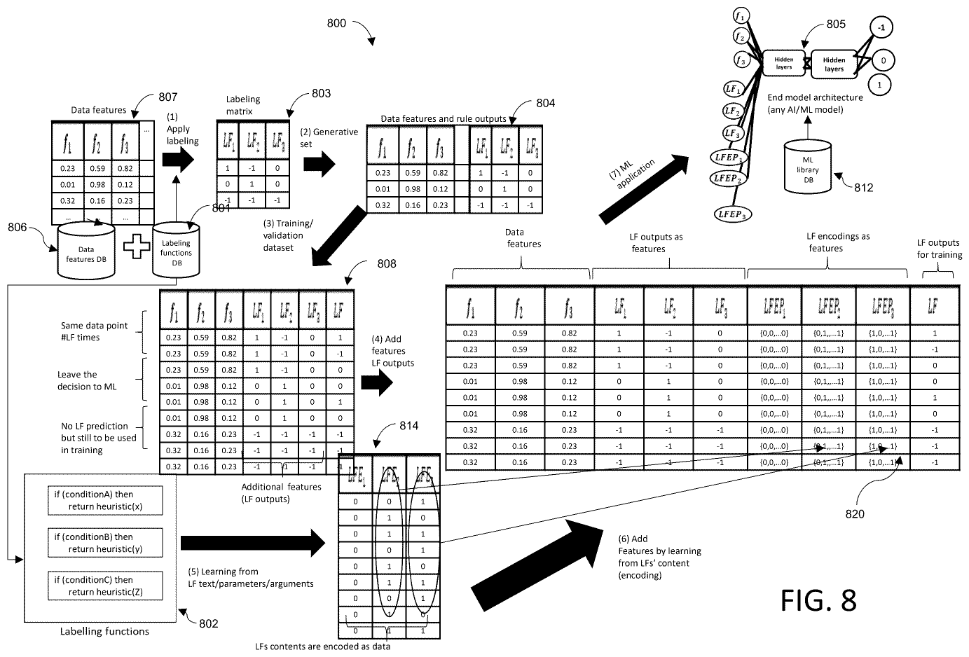

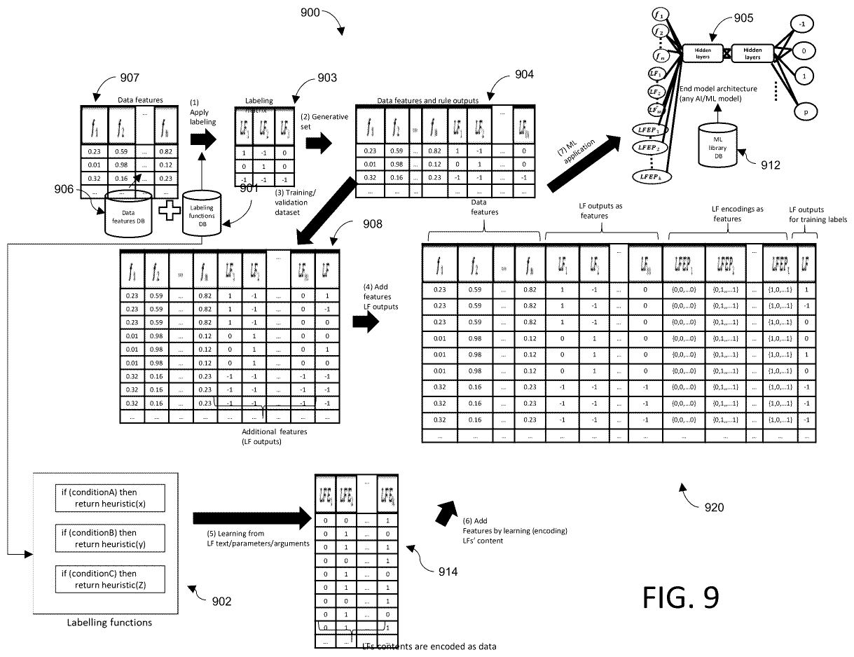

FIG. 8 illustrates another implementation of a technical embodiment of the preprocessing module 800 that additionally includes in the method of preassembling the contents of the labeling functions, in this example with three labeling function (LFs), three data points, and three labeling function encodings (LFEs). FIG. 9 illustrates a technical embodiment of the preprocessing module 900 that implements method for adding labeling functions' content as input features by encoding the relevant labeling function content, in addition to the preassembling model, with any number of data points, data features and LFs, LFEs and LFEPs (e.g., a generalization of the embodiment of FIG. 8 with d data points, n data features, m LFs, k LFEs and t LFEPs). The steps of the methods are as follows:
Step (1) Apply labeling: The data features 807 or 907 are taken from a data features DB 806 or 906 and the labeling functions 802 or 902 are taken from a labeling functions DB 801 or 901. The labeling functions are applied to the data features 807 or 907, thereby creating a labeling matrix 803 or 903.
Step (2) Generative set: A “generative” set 804 or 904 is created, by attaching the labeling matrix 803 or 903 to the data features 807 or 907.
Step (3) Preassembling or generating training/validation dataset 808 or 908: Each data point is duplicated according to the number of LFs. For each such data point, the output of a specific labeling function is added (right-most column on the table).
Step (4) The training/validation dataset is provided for further preassembling.
Step (5) Learning from LF text/parameters/arguments from the labeling functions 802 or 902 from the labeling functions DB 801 or 901, for example using a trained encoder, to encode the LFs' contents as data, or labeling function encodings (LFEs).
Step (6) Further preassembling and adding features by learning (encoding) LFs' content: The LFs' contents encoded in step (5) is added to the output of step (4), in particular as labeling function encoding packets (LFEPs) to generate an updated training/validation dataset 820 or 920 that also includes the LFs' contents encoded as data, in particular the LFEPs.
Step (7) ML application: A multinomial end model 805 or 905 is trained using the input and output features of step (6) and an ML library DB 812 or 912.

Labeling function encodings (LFEs): The LFEs are defined as the “features” from the LF's content. These features can be learned or used directly as they are available. This content may be the internal logic implemented in the labeling function or input/output parameters, or any other important feature. In certain embodiments, where the labeling functions' logic is complex, more complex characteristics can be also learned. For instance, a pretrained machine learning architecture inside a labeling function can be encoded. In other embodiments, the text (code) for the rules or labeling functions can be used. Lastly, any external knowledge that complements the labeling functions 802 or 902 such as an external database with further information about the LFs or available models can be fed as LFEs to be used in the end training.

Labeling function encoding packets (LFEPs): The LFEPs are defined as the data (features) that will be included in the preassembling datasets. The number of LFEPs may or may not be equal to the number of labeling function encodings (LFEs). Various compressing techniques can be applied. In the figures, the packets are shown as the encoded features given as a “set of numbers” and directly added in the preassembled dataset. In other embodiments, the learning from LFs or LFEs can be included with different packaging. Sam, Dylan, et al. consider using input parameters (argument) for the weighting of data point features, whereas they do not consider output, internal logic, text, or inclusion of any additional relevant information to the LF. In contrast, this embodiment considers encoding all available text (program, pseudocode or code) of the LF as well as added relevant information.

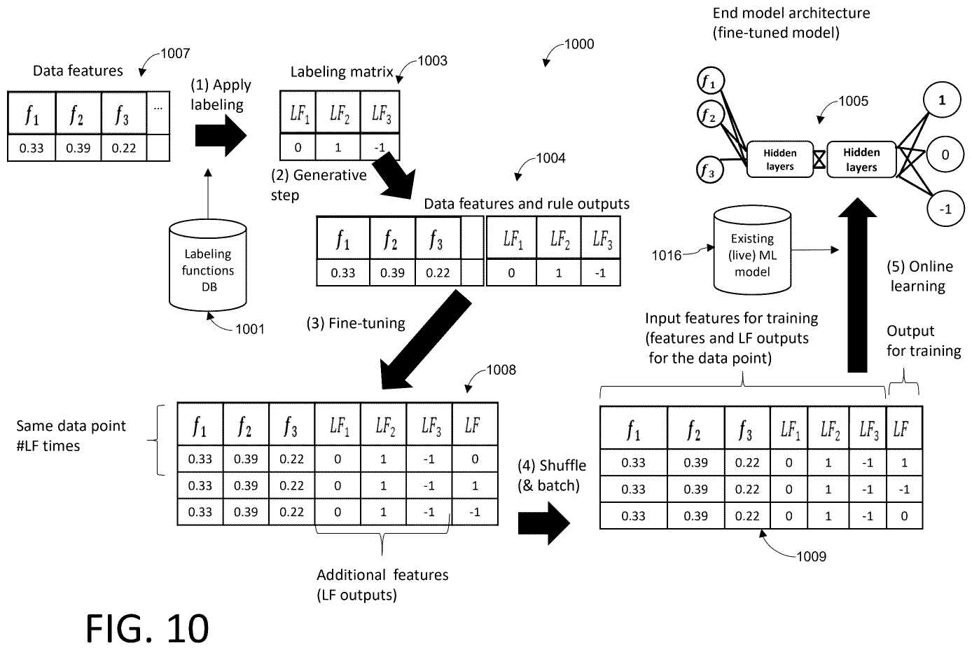

In the following, and with reference to FIG. 10 illustrating a method of an example data point, an exemplary implementation of a technical embodiment for online learning 1000 is described. This embodiment enables the online learning 1000 for any new/unseen data point as the data features 1007. In the online learning 1000, when the new/unseen data point arrives, the model not only predicts the outcome, but also uses the data point as well as all relevant information, such as the existing labeling functions' predictions over the data (see step (2) in FIG. 10).

The steps of the online learning 1000 in FIG. 10 are similar to steps performed by the preassembling module. For example, steps (1)-(5) of FIG. 4 could be performed in a similar manner for steps (1)-(5) for the new data point(s). However, one difference is that the preassembling happens iteratively every time a new data point or set of data points arrive (see step (3) of FIG. 10). In the example of FIG. 10, only one data point is included for simplicity, whereas there can be any number multiple data points (e.g., a new dataset) in typical implementations. The online learning helps fine-tune the existing weakly-supervised machine learning model 1005. Thus, this embodiment would make use of the existing trained (live) ML model 1016 (if available). If a trained model is not available, a model is trained from a newly initialized architecture. Advantages include being able to use the new/unseen data points for training and being able to use all LF outputs, as well as all available features for training.

In the following, an exemplary implementation of a technical embodiment for the module for the weakly-supervised machine learning tailored for preassembled data is described (e.g., for the modules for weakly-supervised ML tailored for preassembled data 211 or 711 of FIGS. 2 and 7). This embodiment proposes different implementation choices for the module, which implements a weakly-supervised machine learning model that is tailored for the preassembled data. Depending on the size of the dataset and availability of the computing resources, this model can utilize the entirety of the preassembled data or only a subset of the preassembled data that is presented by the preassembling module. The model can implement different preprocessing techniques for different features, including input data features, input features that come from the labeling functions and output features. For instance, for categorical data with text, the model can use techniques such as one-hot encoding. The model can do shuffling, create batches or do scaling/normalization. Lastly, the model can utilize (or not utilize) the data points with output features that represent abstain.

The module for the weakly-supervised machine learning tailored for preassembled data can be implemented as a multinomial classification model. In other embodiments, the model can be designed for binary or multinomial classification with preprocessed data rows or output features. For instance, the module can avoid using duplicates and instead rely on aggregated data. In certain embodiments, the weakly-supervised machine learning model can be implemented as a simple heuristic decision-making module (e.g., using statistical tools such as maximum likelihood). In other embodiments, it can utilize more complex machine learning modules such as convolutional neural networks (CNNs), recurrent neural networks (RNNs, e.g., long short-term memories (LSTMs)), generative-adversarial networks (GANs), graph neural networks (GNNs) and so on. The module can leverage AutoML as well as existing techniques. For example, in some embodiments, existing active learning, federated learning or any other technique can be implemented to complement the weak supervision by the module for the weakly-supervised machine learning tailored for preassembled data for certain scenarios.

In certain embodiments, one can already apply statistical methods or machine learning inside the preassembling module to improve the preassembling, and the new system does not require machine learning before the final component.

In certain embodiments, the module for the weakly-supervised machine learning tailored for preassembled data can consider treating the data features and the input features that are coming from the labeling function outputs separately. For instance, the weakly-supervised model can consist of two different (auto) encoders, one for the input data features, and one for the labeling function outputs used as the input features.

In certain embodiments, the preassembling module can pack the labeling function outputs using an encoding. In other embodiments, the preassembling module can apply different preprocessing techniques. This can be both for the input data features or for the labeling function outputs.

In certain embodiments, the preassembling module can selectively include labeling functions' predictions as the output features. In other embodiments, the preassembling module can compress the predictions or have probabilistic predictions for data points. For instance, for one data point, the preassembling module can take a mean value of predictions of all labeling functions.

In certain embodiments, the module for the weakly-supervised ML tailored for preassembled data can have a component at the end which makes the selection of the output label. This component can look at all probabilities coming for all possible outcomes and choose the highest. Alternatively, it can make a probabilistic estimate.

Embodiments of the present invention can be applied in a number of technical domains, such as digital medicine and automated or personalized healthcare, AI-assisted drug development or vaccine development, material or composition development, smart factories, smart industry, smart districts, market segmentation, recommender systems, predictive maintenance and energy control, wherein the enhanced functionality of preassembling to achieve greater efficiency, prediction accuracy and reliability can provide further improvements in those technical domains.

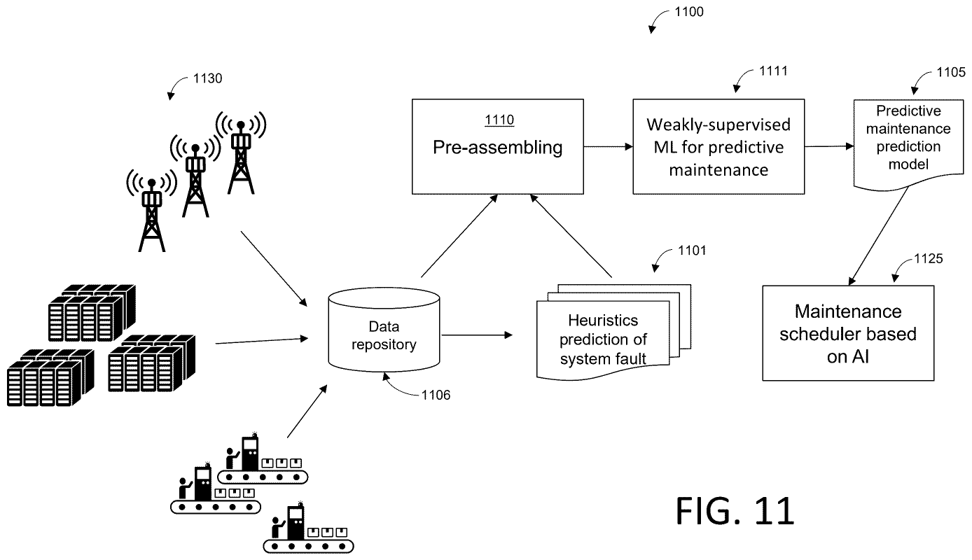

In one technical application illustrated in FIG. 11, an embodiment of the present invention is applied to a method for predictive maintenance of systems 1100. A smart industry system 1130 is composed of machines, data centers and a network. The production efficiency and output depends on the whole system to work properly. In case one of the components is faulty, the production would suffer and resources would be wasted. Reacting to component faults is more costly in terms of human and computational time and resources than pro-actively planning a maintenance operation. However, it is hard to forecast faulty situations. Mathematical models can be used to simulate the behavior of the components to identify an anomaly. However, the heuristics 1101 for prediction of system fault, stored in a database, are based on human experience and, thus, they only produce scarce anomaly identification. Further, those heuristics 1101 are often not considering all the possible anomaly situations. In addition, the mathematical models often do not simulate the system as a whole because every deployment is different than another. In this technical application, the data sources include (but are not limited to) the following: sensors that are deployed in machines/robots, weight sensors, wireless sensors, image/video data, remote commands, pressure sensors, gyroscopes, robots' dynamic maps, environment sensors (e.g., temperature), etc., that produce data features stored in a data repository 1106. Implementation of the method according to an embodiment of the present invention leverages the scarce output from the heuristics 1101 through the preassembling module 1110. The output is then used by the module for the weakly-supervised ML tailored to preassembled data for predictive maintenance 1111 to produce a machine learning model, in particular a predictive maintenance prediction model 1105 which can be used in an automated tool for adjusting, actuating or scheduling components of the smart industry system, such as a maintenance scheduler 1125 based on AI. The maintenance scheduler 1125, by the improved predictive maintenance prediction model 1105, enables increased system robustness and resilience. In some embodiments, using the online learning approach allows to refine the machine learning model and the overall robustness and resilience of the smart industry deployment.

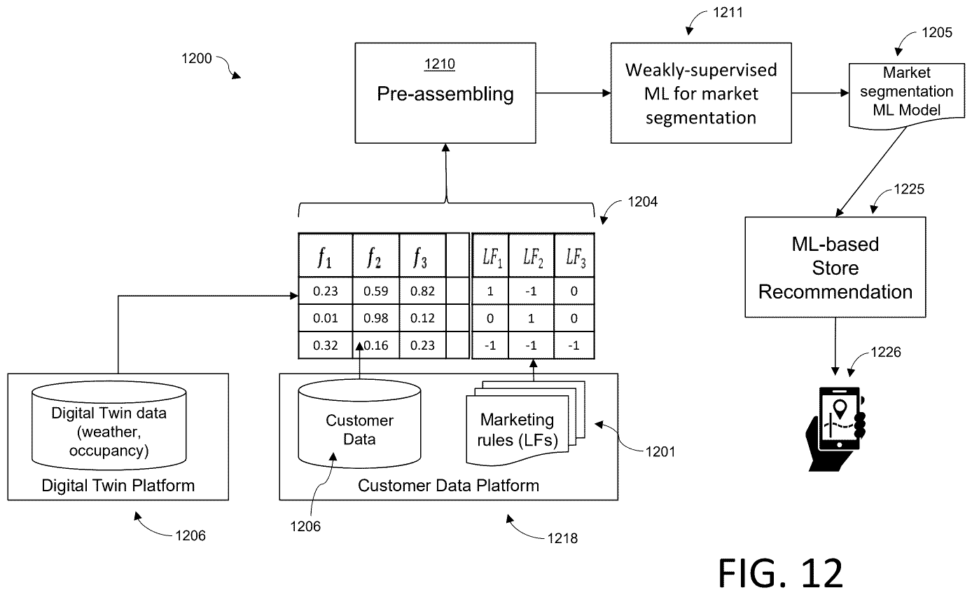

In one technical application illustrated in FIG. 12, an embodiment of the present invention is applied for a method for market segmentation 1200, for example for a recommender or personalization system where the output can be, for example, recommending a store to a customer. A customer data platform 1218 manages the customer data 1216 and offers the possibility of executing marketing rules 1201, stored in a database, on the customer data 1216 for marketing purposes, such as market segment identification for a specific customer. As an example, a customer can be a chain of stores where each branch data is collected in the customer's data platform. However, the marketing rules 1201 are heuristics that change with time (different customers' trends) and location (different customers' trends depending on the local habits). Increasing the accuracy of the segment identification increases efficiency, revenue and customer satisfaction. Implementation of the method according to an embodiment of the present invention enables the creation of an ML-based market segmentation model 1205 by leveraging the faulty and incomplete output of marketing rules 1201, and combines them also with external Digital Twin information from a Digital Twin platform 1206 containing Digital Twin information, for example, from physical sensors located at a location or from a scenario that is being simulated (e.g., from weather or occupancy sensors), where applicable. In general, for all embodiments, such Digital Twin information can be included in the data features when applicable and available. The data features 1204 are preassembled using a preassembling module 1210 and provided to the module for the weakly-supervised ML for market segmentation 1211 to generate the ML-based market segmentation model 1205, which can be implemented in an automated tool, such as an ML-based store recommender 1225, to provide automated and personalized recommendations, and/or other related information based thereon, such as directions to a store, to a user device 1226. In some embodiments, the online learning approach allows to refine the machine learning model and the accuracy of the prediction (e.g., store recommendation).

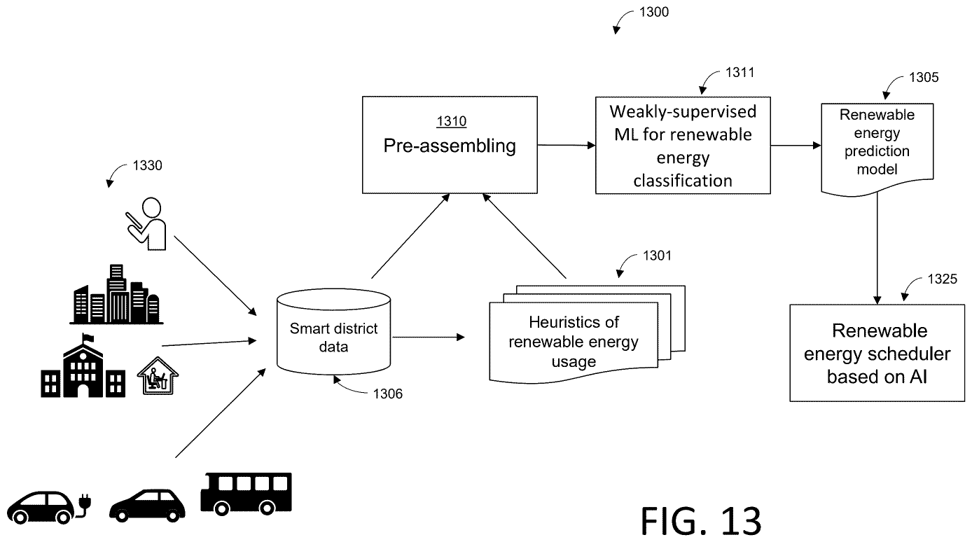

In one technical application illustrated in FIG. 13, an embodiment of the present invention is applied for control of a smart district 1330 (e.g., a smart city, a smart factory or a smart building), in particular as a method for automated control of energy 1300. Especially in smart districts, ground-truth data collection is difficult and has high human and computational cost in terms of time and resources. For instance, in the energy domain, it is hard to collect data about classifying the used energy resources such as renewable (wind, solar, etc.) and non-renewable (e.g., fuel) energy sources to be used in the correct timing. On the other hand, each neighborhood in the smart district 1330 could follow a set of rules for their energy usage, or heuristics of renewable energy usage 1301, which can be stored in a database, and make the decisions on the energy resources' usage automatically by training an AI model with collected data features stored in a database of smart district data 1306. The data features can be any data collected from the smart district 1330 such as data from buildings, mobility, expectations of people and environment data (e.g., relating to climate), for example as collected by physical sensors located in the smart district and/or Digital Twin data, where applicable. The heuristics 1301 (rules) can be implemented as labeling functions. These rules are applied to the smart district data 1306 with the preassembling module 1310, such that all relevant information is taken to the end prediction model (renewable energy prediction model 1305). The end renewable energy prediction model 1305 takes all existing patterns including raw data features, labeling functions predictions (outputs), and content from the labeling functions themselves (the internal logic), and the model is tailored towards these three patterns during its training phase and prediction phase to make more accurate and efficient decisions that result in improved efficiency, comfort and energy savings. For example, the renewable energy prediction model 1305 can be implemented in an automated tool such as a renewable energy scheduler 1325 based on AI to take automated control actions in the smart district 1330, such as controlling sensors, batteries, renewable or non-renewable energy resources, or activating or adjusting building heating, ventilation and air conditioning (HVAC) equipment.

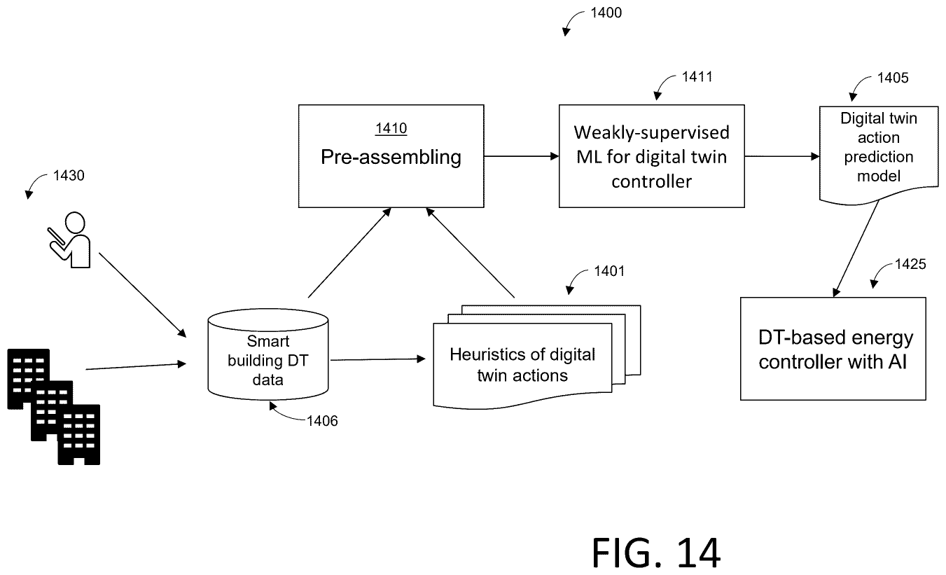

In one technical application illustrated in FIG. 14, an embodiment of the present invention is applied for method for controlling a smart building 1400. In this embodiment, a Digital Twin (DT) of the smart building is created using all available DT data 1430 including data from sensors that are deployed inside or in a vicinity of the building, data collected from people using the building, building models (e.g., 3D models), etc. and this information is stored in a database of smart building DT data 1406. The Digital Twin runs a service for its actions to preserve energy consumption in the smart building. All available data and the actions run by a service together comprise the Digital Twin of the smart building. Building sensors include (but are not limited to) the following: room/building occupancy sensors, RFID, Bluetooth, Wi-Fi sensors, CO₂ sensors, humidity sensors, air quality (e.g., PM10) sensors, lightning (luminosity) sensors, indoor/outdoor temperature sensors, parking occupancy and availability sensors, a 3D map of the building heating, ventilation and air conditioning (HVAC) system configurations, operating machines (on and off machines), locations of any equipment or furniture, temporal features (e.g., day of the week), weather information, event schedules, smart meters, etc. There can be an existing set of heuristics of digital twin actions 1401 as a set of rules or labeling functions that can be applied to the smart building DT data, and preassembled therewith by the preassembling module 1410 and used as input for a module for weakly-supervised ML for a digital twin controller 1411 to generate an end digital twin prediction model 1405. Various automated actions can be taken from the digital twin to the physical object (building), for example using a DT-based energy controller 1425 with AI that implements the digital twin prediction model 1405. One example is an HVAC controller of HVAC configurations of a smart building. The configurations can be adjusted by AI predictions, where implemented heuristics (labeling functions) and smart building digital twin data is composed by the preassembling model, such that the AI model can use the preassembling for its decisions on HVAC control to improve efficiency and conserve physical resources. Similarly, various events in buildings or smart districts can be optimized using existing rules and heuristics from these domains, along with all available digital twin information.

Embodiments of the present invention can also be used for medical use cases, for example, for predicting medical conditions, medications or treatments, or lengths of stays for patients, or for AI drug development or vaccine design. Since the type of final ML model is not limited and embodiments of the present invention provide to improve the weakly-supervised machine learning generally, embodiments of the present invention have many use cases and can provide further improvements in a number of technical fields.

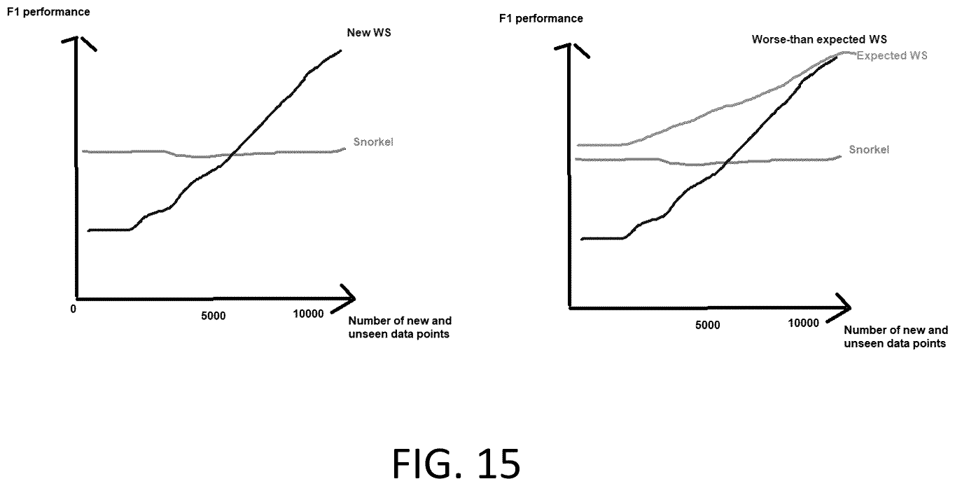

FIG. 15 graphically illustrates experimental performance results. The experiments tested performance of the weakly-supervised model according to an embodiment of the present invention (“New WS”), which provides to train and predict at the same time, against the existing Snorkel approach, which uses a model that predicts only. The number of data points is as follows: m new data points=number of LFs * m new training points+m prediction points. The graphs show the F1 performance depending on the number of new/unseen data points.

In an embodiment, the present invention provides a method for generation of a machine learning model without the need for ground truth information and with a minimal number of labeling functions, the method comprising the steps of:
Step 1. Create a database with (raw or preprocessed) data features.
Step 2. Create a database with labeling functions (rules).
Step 3. Create a labeling matrix by applying the labeling functions on the data points with the data features.
Step 4. In some embodiments, using a label encoding module to apply labeling function encodings. The encoding can be done by any possible way to encode the content of the labeling functions as numbers, including its input, output parameters and functions' internal text or models/algorithms.
Step 5. Preassembling module: For each data point, merge raw data features, labeling function outputs and labeling function encoding packets as input features.
Step 6. Preassembling module: For each data point, create one or multiple predictions based on the labeling functions' outputs on the data point. The predictions can be each labeling function output, and the data points can be repeated in the preassembled data for the number of labeling function outputs so that each labeling function output is included as a prediction.
Step 7. Weakly-supervised machine learning tailored for preassembled data module: Create a machine learning model that optimizes the loss based on the input features given in Step 5 and output features given in Step 6.
Step 8. For any new/unseen data point, predict the label using the trained model in Step 7.

Embodiments of the present invention provide the following improvements over existing technology:
1. Providing a preassembling module which enables merging labeling function outputs and labeling function encodings as additional input features along with the initially existing data features, to present labeling function patterns to the end model in a more efficient way, without bias and without requiring ground truth information.
2. Providing a weak-supervision module (e.g., the weakly-supervised machine learning tailored for preassembled data module of FIG. 1) which enables optimizing based on duplicate data points and three types of input features: data features, labeling function predictions and labeling function encodings.
3. Fewer heuristics (labeling functions) are needed because also the unlabeled data are used for the ML model training, thereby resulting in greater computational efficiency and saving computational resources.
4. There is no need for creating/training a generative model or any heuristics before the end model, thereby further improving computational efficiency and saving computational resources, while also avoiding filtering out of data points.

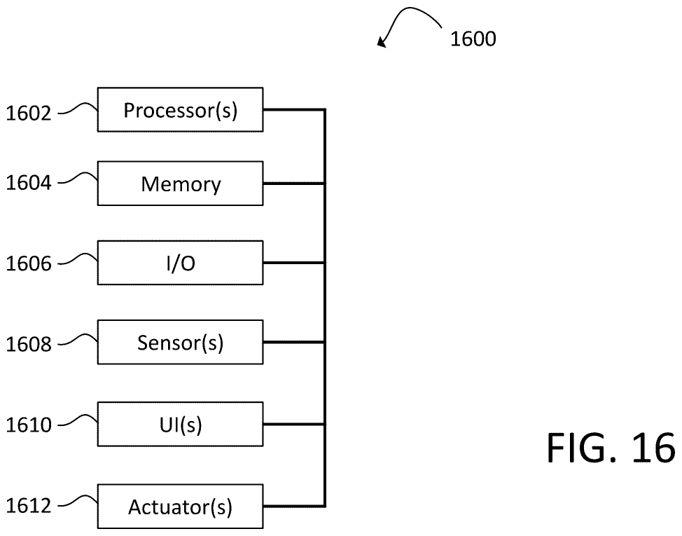

Referring to FIG. 16, a processing system 1600 can include one or more processors 1602, memory 1604, one or more input/output devices 1606, one or more sensors 1608, one or more user interfaces 1610, and one or more actuators 1612. Processing system 1600 can be representative of each computing system disclosed herein.

Processors 1602 can include one or more distinct processors, each having one or more cores. Each of the distinct processors can have the same or different structure. Processors 1602 can include one or more central processing units (CPUs), one or more graphics processing units (GPUs), circuitry (e.g., application specific integrated circuits (ASICs)), digital signal processors (DSPs), and the like. Processors 1602 can be mounted to a common substrate or to multiple different substrates.

Processors 1602 are configured to perform a certain function, method, or operation (e.g., are configured to provide for performance of a function, method, or operation) at least when one of the one or more of the distinct processors is capable of performing operations embodying the function, method, or operation. Processors 1602 can perform operations embodying the function, method, or operation by, for example, executing code (e.g., interpreting scripts) stored on memory 1604 and/or trafficking data through one or more ASICs. Processors 1602, and thus processing system 1600, can be configured to perform, automatically, any and all functions, methods, and operations disclosed herein. Therefore, processing system 1600 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 1600 can be configured to perform task “X”. Processing system 1600 is configured to perform a function, method, or operation at least when processors 1602 are configured to do the same.

Memory 1604 can include volatile memory, non-volatile memory, and any other medium capable of storing data. Each of the volatile memory, non-volatile memory, and any other type of memory can include multiple different memory devices, located at multiple distinct locations and each having a different structure. Memory 1604 can include remotely hosted (e.g., cloud) storage.

Examples of memory 1604 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 1604.

Input-output devices 1606 can include any component for trafficking data such as ports, antennas (i.e., transceivers), printed conductive paths, and the like. Input-output devices 1606 can enable wired communication via USB®, DisplayPort®, HDMI®, Ethernet, and the like. Input-output devices 1606 can enable electronic, optical, magnetic, and holographic, communication with suitable memory 1606. Input-output devices 1606 can enable wireless communication via WiFi®, Bluetooth®, cellular (e.g., LTE®, CDMA®, GSM®, WiMax®, NFC®), GPS, and the like. Input-output devices 1606 can include wired and/or wireless communication pathways.

Sensors 1608, such as cameras in a smart city application, can capture physical measurements of environment and report the same to processors 1602. User interface 1610 can include displays, physical buttons, speakers, microphones, keyboards, and the like. Actuators 1612 can enable processors 1602 to control mechanical forces.

Processing system 1600 can be distributed. For example, some components of processing system 1600 can reside in a remote hosted network service (e.g., a cloud computing environment) while other components of processing system 1600 can reside in a local computing system. Processing system 1600 can have a modular design where certain modules include a plurality of the features/functions shown in FIG. 16. For example, I/O modules can include volatile memory and one or more processors. As another example, individual processor modules can include read-only-memory and/or local caches.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented method for generation of a machine learning model using weak supervision, the method comprising:
generating a labeling matrix of labeling function outputs by applying labeling functions to data features;
preassembling the labeling function outputs together with the data features for each data point to generate a training dataset; and
training the machine learning model using the training dataset.

2. The method according to claim 1, further comprising generating one or more predictions based on the labeling function outputs and including the one or more predictions in the training dataset, wherein the labeling function outputs together with the data features for each data point are used as input for training the machine learning model, and wherein the one or more predictions are used as output for training the machine learning model.

3. The method according to claim 1, wherein the machine learning model is trained to optimize a loss based on the training dataset, which provides the labeling function outputs together with the data features for each data point as input for the training and the one or more predictions based on the labeling function outputs as output for the training.

4. The method according to claim 1, wherein a loss function is used for training the machine learning model as follows:
$$Loss ( θ ) = \frac{1}{\vert D \vert * m} {\sum }_{i = 1}^{\vert D \vert} {\sum }_{j = 1}^{m} Error ( {y}_{predicted}^{i} \vert {f}_{1}^{i} , {f}_{2}^{i} , … {f}_{n}^{i} , {LF}_{1}^{i} , {LF}_{2}^{i} , … {LF}_{m}^{i} ; {LF}_{j}^{i} )$$
where:
$$L {F}_{j}^{i}$$
represents a prediction value of the j^{th} labeling function's prediction value over a respective data point indexed with i,
D represents the data points including the data points that are abstained by one or more of the labeling functions,
m represents a total number of the labeling functions,
$${f}_{1}^{i} , {f}_{2}^{i} , … {f}_{n}^{i}$$
represent the data features for each data point in the training dataset as input features,
$$L {F}_{1}^{i} , L {F}_{2}^{i} , … {LF}_{m}^{i}$$
represent the labeling function outputs in the training dataset as additional input features, and
$${y}_{predicted}^{i}$$
is a prediction of the machine learning model based on the input features.

5. The method according to claim 1, further comprising:
encoding content of the labeling functions as values to generate labeling function encodings, wherein the content includes input/output parameters, internal text, logic and/or architecture of the labeling functions; and
preassembling the labeling function encodings in the training dataset.

6. The method according to claim 5, wherein the labeling function encodings are preassembled in the training dataset as labeling function encoding packets for each data point including a set of the labeling function encodings for each labeling function.

7. The method according to claim 6, wherein a loss function is used for training the machine learning model as follows:
$$Loss ( θ ) = \frac{1}{\vert D \vert * m} {\sum }_{i = 1}^{\vert D \vert} {\sum }_{j = 1}^{m} Error ( {y}_{predicted}^{i} \vert {f}_{1}^{i} , {f}_{2}^{i} , … {f}_{n}^{i} , {LF}_{1}^{i} , {LF}_{2}^{i} , … {LF}_{m}^{i} , LFE {P}_{1}^{i} , {LFEP}_{2}^{i} , … {LFEP}_{t}^{i} ; {LF}_{j}^{i} )$$
where:
$$L {F}_{j}^{i}$$
represents a prediction value of the j^{th} labeling function's prediction value over a respective data point indexed with i,
D represents the data points including the data points that are abstained by one or more of the labeling functions,
m represents a total number of the labeling functions,
$${f}_{1}^{i} , {f}_{2}^{i} , … {f}_{n}^{i}$$
represent the data features for each data point in the training dataset as input features,
$$L {F}_{1}^{i} , L {F}_{2}^{i} , … {LF}_{m}^{i}$$
represent the labeling function outputs in the training dataset as additional input features,
$${LFEP}_{1}^{i} , {LFEP}_{2}^{i} , … {LFEP}_{t}^{i}$$
represent t number of the labeling function encoding packets in the training dataset as further input features, and
$${y}_{predicted}^{i}$$
is a prediction of the machine learning model based on the input features.

8. The method according to claim 1, further comprising shuffling and batching the training dataset prior to using the training dataset to train the machine learning model.

9. The method according to claim 1, further comprising fine-tuning the machine learning model using at least one new and unseen data point for which the machine learning model makes a prediction, wherein the labeling functions are applied to the at least one new and unseen data point and are preassembled with the at least one new and unseen data point to generate a further training dataset used to further train the machine learning model in an iterative manner.

10. The method according to claim 1, wherein the data features include values from sensors and data sources in a smart industry system and the labeling functions include heuristics on system fault based on experience, and wherein the machine learning model is trained for predictive maintenance of components of the smart industry system and is implemented in a maintenance scheduling tool.

11. The method according to claim 1, wherein the data features include customer data and/or data from a digital twin simulation and the labeling functions include marketing rules, and wherein the machine learning model is trained for market segmentation and is implemented in a store recommendation tool.

12. The method according to claim 1, wherein the data features include data collected from a smart district including values from sensors indicating energy usage in the smart district and the labeling functions include rules on energy usage in the smart district, and wherein the machine learning model is trained for energy predictions for the smart district and is implemented in a scheduler tool configured to control energy usage in the smart district based on predictions of the machine learning model.

13. The method according to claim 1, wherein the data features include values from sensors and data sources in a smart building and/or data from a digital twin simulation of the smart building and the labeling functions include heuristics on actions of the digital twin simulation, and wherein the machine learning model is trained for predicting digital twin actions and is implemented in an energy controller of the smart building.

14. A computer system comprising one or more hardware processors which, alone or in combination, are configured to provide for execution of a method for generation of a machine learning model using weak supervision comprising the following steps:
generating a labeling matrix of labeling function outputs by applying labeling functions to data features;
preassembling the labeling function outputs together with the data features for each data point to generate a training dataset; and
training the machine learning model using the training dataset.

15. A tangible, non-transitory computer-readable medium having instructions thereon, which, upon being executed by one or more processors provide for execution of a method for generation of a machine learning model using weak supervision comprising the following steps:
generating a labeling matrix of labeling function outputs by applying labeling functions to data features;
preassembling the labeling function outputs together with the data features for each data point to generate a training dataset; and
training the machine learning model using the training dataset.
